(19) United States
(12) Patent Application Publication
(10) Pub. No.: US 2009/0314572 A1
(43) Pub. Date: Dec. 24, 2009

(54) Closed center valve steering system with adjustable pressure

(75) Inventors: William A. Szabela, Brookston, IN (US); Daniel E. Williams, Lebanon, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 12/214,493

(22) Filed: Jun. 19, 2008

(51) Int. Cl. B62D 5/06

(52) U.S. Cl. 180/422

(57) ABSTRACT

The present invention relates to an apparatus (10) for helping to turn steerable wheels (15) of a vehicle. The apparatus includes a hydraulic power-assisted steering gear (130), a fluid source (20) for supplying the steering gear (130) with hydraulic fluid, and a controller (52) for controlling the fluid source. The steering gear (130) includes a closed center valve (150) operatively connected with a vehicle steering wheel (12) and in fluid communication with the fluid source. The controller (52) is responsive to the pressure of the hydraulic fluid for controlling the fluid source (20) to supply the steering gear (130) with hydraulic fluid at a first predetermined pressure when the vehicle is in a first condition. The controller (52) is responsive to the pressure of the hydraulic fluid for controlling the fluid source (20) to supply the steering gear (130) with hydraulic fluid at a second predetermined pressure when the vehicle is in a second condition.

### TECHNICAL FIELD

The present invention relates to a steering apparatus for a vehicle having steerable wheels.

### BACKGROUND OF THE INVENTION

Integral hydraulic steering gears are commonly used to provide hydraulic power-assisted steering for over-the-road trucks and for off-road vehicles, such as earth-moving vehicles and other construction equipment. “Integral” refers to a steering gear containing a manual steering mechanism, a hydraulic motor, and a hydraulic control valve assembly integrated into a single unit.

The hydraulic motor of an integral steering gear typically comprises a cylinder and a piston received in the cylinder so as to define two chamber portions in the cylinder. The piston has a set of external teeth, which mesh with teeth on a sector gear fixed to an output shaft. The output shaft is connected via steering linkage to steerable wheels of a vehicle to steer the vehicle when the output shaft is rotated.

The hydraulic control valve assembly of an integral steering gear controls flow of pressurized hydraulic fluid between a hydraulic pump and one of the chamber portions of the hydraulic motor to control the direction and amount of steering. One type of control valve assembly includes a closed center valve. In an integral steering gear with a closed center valve, hydraulic fluid flow to the two chamber portions of the hydraulic motor is blocked by the valve when the steering wheel is centered and no steering of the steerable wheels is underway.

In a steering system that includes an integral steering gear with a closed center valve assembly, the hydraulic pump is generally running at all times when the engine of the associated vehicle is running. Nonetheless, when the vehicle is in motion, less pressure is required to turn the steerable wheels than when the vehicle is stationary. Continuous operation of the pump to provide hydraulic fluid at a fixed pressure results in energy use that could be reduced by adjusting the pump output in accordance with hydraulic fluid or pressure requirements. Further, when the valve opens, hydraulic fluid suddenly flows to the hydraulic motor. This produces a large initial force that is applied to the steerable wheels and the steering shaft, thereby creating a disturbance or “bump” in the steering “feel” experienced by the driver. This large initial flow of hydraulic fluid also creates unnecessary pressure in the valve, the motor and the hydraulic line connecting them. Such high pressure may cause leakage of hydraulic fluid from these components.

### SUMMARY OF THE INVENTION

The present invention relates to an apparatus for helping to turn steerable wheels of a vehicle. The apparatus includes a hydraulic power-assisted steering gear, a fluid source for supplying the steering gear with hydraulic fluid, and a controller for controlling the fluid source. The steering gear includes a closed center valve operatively connected with a vehicle steering wheel and in fluid communication with the fluid source. The controller is responsive to the pressure of the hydraulic fluid for controlling the fluid source to supply the steering gear with hydraulic fluid at a first predetermined pressure when the vehicle is in a first condition. The controller is responsive to the pressure of the hydraulic fluid for controlling the fluid source to supply the steering gear with hydraulic fluid at a second predetermined pressure when the vehicle is in a second condition.

### BRIEF DESCRIPTION OF THE DRAWINGS

Further features and advantages of the present invention will be apparent to those skilled in the art to which the present invention relates from the following detailed description of preferred embodiments of the present invention made with reference to the accompanying drawings, in which:

FIG. 1 is a schematic diagram of a steering apparatus embodying the present invention;

FIG. 2 is a sectional view of an integral hydraulic power steering gear that forms a part of the steering apparatus of FIG. 1; and

FIG. 3 is a fragmentary sectional view of a closed center control valve that forms part of the integral hydraulic power steering gear of FIG. 2.

### DESCRIPTION OF PREFERRED EMBODIMENTS

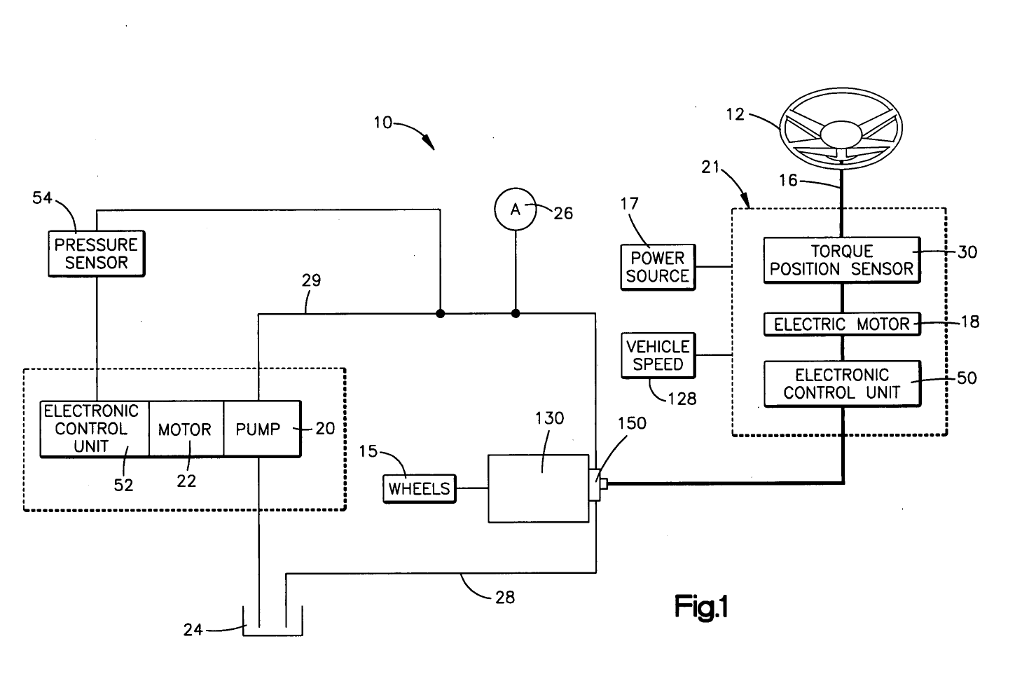

FIG. 1 shows a hydraulic power steering apparatus 10 for a vehicle having steerable road-engaging wheels 15. The apparatus includes a hand or steering wheel 12, which is rotated manually by a driver of the vehicle. The hand wheel 12 is connected to a steering shaft 16 such that rotation of the hand wheel causes rotation of the shaft 16 (FIG. 1). The steering shaft 16 is connected to the steerable wheels 15 through an integral hydraulic steering gear 130. The integral hydraulic steering gear 130 receives pressurized hydraulic fluid from a hydraulic pump 20 and an accumulator 26 via a supply line 29.

The steering apparatus 10 further includes a torque/position sensor 30, an electric motor 18, and a first electronic control unit 50. These three components are integrated into a single unit 21 and are associated with the shaft 16. The torque/position sensor 30 is operable to sense torque applied to and rotation of the hand wheel 12 by the driver. The electric motor 18 is operable to provide road “feel” by resisting turning of the hand wheel 12 and shaft 16 by the driver. The first electronic control unit 50 receives information from the torque/position sensor 30, and, based at least in part on such information, controls the output of the electric motor 18.

The sensor 30 encircles the shaft 16 and may include a torsion bar between shaft parts and a sensor for sensing relative rotation of the shaft parts. The sensor 30 determines the torque applied to the hand wheel 12 and the angular position of the hand wheel 12. The unit 21 could optionally include one or more additional torque/position sensors 30 in order to have redundancy in case a problem develops with the primary torque/position sensor.

The electric motor 18 is associated with the shaft 16 and is activated to provide road feel by resisting turning of the shaft 16 by the driver of the vehicle. The electric motor 18 may be any suitable variable speed reversible electric motor that can resist turning of the shaft 16 when the hand wheel 12 is turned in either a clockwise or counterclockwise direction.

When the electric motor 18 is energized by electric power from a power source 17, the output shaft of the electric motor 18 applies a force to the shaft 16 to provide a steering “feel” to the vehicle operator. This force tends to bias (or drive) the shaft 16 to rotate in a direction opposite to the direction in which the vehicle operator is turning the hand wheel 12.

The electric motor 18 is controlled by the first electronic control unit 50 to provide the proper steering “feel” to the hand wheel 12. The first electronic control unit 50 receives the output signal from the torque/position sensor 30 to help determine the output torque of the electric motor 18. The first electronic control unit 50 also receives signals generated by a vehicle speed sensor 128. The vehicle speed sensor 128 senses the vehicle speed and generates an electrical signal indicative of the sensed speed.

The first electronic control unit 50 compares the signals from the sensors 30 and 128 to stored reference values. The reference values may take the form of look-up tables stored in the memory of the first electronic control unit 50. When the comparison indicates that the signals from the sensors 30 and 128 correspond to particular reference values, the electric motor 18 is activated by the first electronic control unit 50 and outputs a corresponding torque to the hand wheel 12 and shaft 16 to resist the turning of the hand wheel 12 and shaft 16 by the driver. The output of the motor varies with respect to the signals from the sensors 30 and 128 in order to provide the proper steering “feel” to the hand wheel 12. The first electronic control unit 50 is powered by the power source 17.

The apparatus 10 further includes the pump 20. A second electric motor 22 is operatively connected to the pump 20 to drive the pump. The pump 20 may be driven in a different manner, if desired. For example, the pump 20 may be driven by an engine of the vehicle.

The pump 20 has an inlet and an outlet. The inlet is in fluid communication with a reservoir 24. The outlet from the pump 20 is in fluid communication with an accumulator 26 and the integral steering gear 130 via a hydraulic fluid supply line 29. A return line 28 from the integral steering gear 130 is in fluid communication with the reservoir 24.

When actuated, the pump 20 draws fluid from the reservoir 24 and supplies the fluid to the accumulator 26. The pressure sensor 54 senses the pressure in the accumulator 26. The pump 20 charges the accumulator 26 until the pressure in the accumulator 26 reaches an upper limit as measured by the pressure sensor 54 or other suitable device.

A second electronic control unit 52 is connected to the motor 22 for controlling the pump 20. A pressure sensor 54 is electrically coupled to the second electronic control unit 52 and is in fluid communication with the hydraulic fluid supply line 29. The pressure sensor 54 senses the pressure in the supply line 29 and outputs a signal indicative of the pressure to the second electronic control unit 52.

The second electronic control unit 52 stores reference values for pressure in the supply line 29 and for vehicle speed. The reference values for the pressure in the supply line 29 correspond to values for vehicle speed and reflect the effort needed to steer the wheels with minimal energy loss by the system. For example, when the vehicle is parked or idled and the hand wheel 12 is centered with the steerable wheels 15 in a straight ahead orientation, the reference value for the pressure in the supply line 29 may be 2175 psi. When the vehicle is cruising at a speed of 65 mph and the hand wheel 12 is centered with the steerable wheels 15 in a straight ahead orientation, the reference value for the pressure in the supply line 29 may be 500 psi, because less pressure is required to steer the wheels 15. It should be noted that this is just one example. The reference values may change depending on the desired steering force and/or particular requirements of the steering system.

The reference values may take the form of look-up tables stored in the memory of the second electronic control unit 52. The second electronic control unit 52 compares the actual pressure sensed by the sensor 54 to the stored reference value for the current vehicle speed. If the pressure is below the reference value, the second electronic control unit 52 directs the motor 18 to drive the pump 20 until the pressure reaches or exceeds the reference value. This increases the pressure in the accumulator 26. Hydraulic fluid under pressure is supplied to the steering gear 130 from the accumulator 26 through supply line 29.

The first electronic control unit 50 also communicates with the second electronic control unit 52. In particular, the first electronic control unit 50 sends a CAN message containing steering rate information of the hand wheel 12 based on the torque/position sensor 30 to the second electronic unit 52. This steering rate information is used by the second electronic unit 52 to adjust the speed of the motor 22 for the pump 20 according to a calibration lookup table in the second electronic unit 52.

For example, if there is no movement of the hand wheel 12, the pump 20 would not need to supply hydraulic fluid to turn the steerable wheels 15. In this situation, the electronic unit 52 would receive the steering rate information from the electronic control unit 50 and possibly command the motor 22 to turn off to save energy. If on the other hand, there is substantial steering movement of the hand wheel 12, the pump 20 would need to charge the accumulator to maintain sufficient steering pressure. In this situation, the electronic unit 52 would receive the steering rate information from the electronic unit 50 and adjust the speed of the motor 22 to control the pump 20 to control the flow of hydraulic fluid based on this steering rate information.

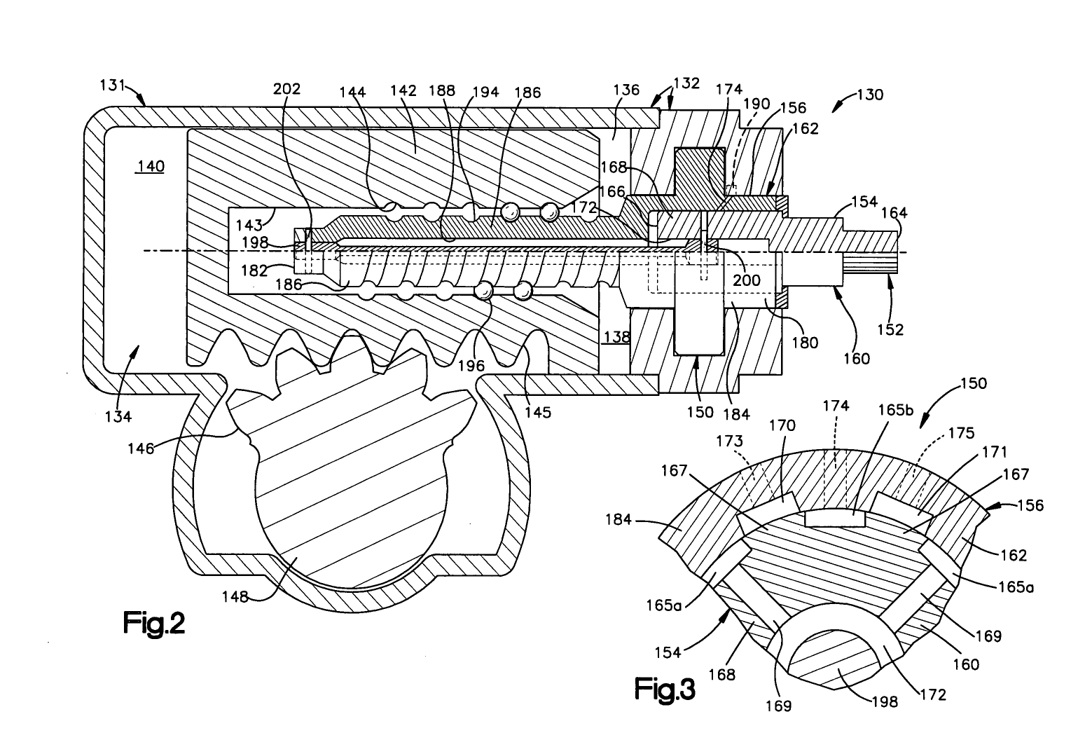

Referring to FIG. 2, the steering gear 130 is an integral hydraulic steering gear, which includes a hydraulic motor 131, a hydraulic control valve 150, and a manual steering mechanism. The integral hydraulic power steering gear 130 includes a two-piece housing 132. One piece of the housing 132 is a hydraulic cylinder 134 (FIG. 2). The cylinder 134 defines a chamber 136, which receives a piston 142. The piston 142 divides the cylinder 134 into two chamber portions 138 and 140.

The piston 142 includes an inner bore 143 with a helical groove 144. The piston 142 also has a set of external teeth 145, which mesh with the teeth of a sector gear 146. The sector gear 146 is fixed to an output shaft 148, which extends outwardly from the housing 132. The output shaft 148 is connected to a pitman arm (not shown), which, in turn, is connected via steering linkage to the steerable wheels 15 to steer the vehicle. As the piston 142 moves in the chamber 136, the output shaft 148 is rotated to operate the steering linkage, which turns the steerable wheels 15 of the vehicle.

A closed center control valve assembly 150 (FIG. 3) controls the flow of pressurized hydraulic fluid between the accumulator 26 (FIG. 1) and the chamber portions 138 and 140 to control the direction and amount of power assistance for steering. The valve assembly 150 (FIG. 2) is actuated by a rotatable input shaft 152. The input shaft 152 is rotated by the shaft 16. The valve assembly 150 comprises first and second valve members 154 and 156 (FIG. 2), respectively. The first valve member 154 comprises a rotatable valve core 160 (FIG. 3), and the second valve member 156 comprises a rotatable valve sleeve 162. The valve core 160 is located coaxially within the valve sleeve 162 and is supported for rotation by the valve sleeve. The valve core 160 is formed as one piece with the input shaft 152 (FIG. 2). The valve core 160 has oppositely disposed first and second axial end portions 164 and 166, respectively, and a valve section 168 between the end portions. The first end portion 164 of the valve core 160 projects beyond the valve sleeve 162, but the second end portion 166 of the valve core lies within the valve sleeve.

The valve section 168 (FIG. 3) of the valve core 160 has a plurality of circumferentially spaced, axially extending grooves 165a and 165b disposed between lands 167, as is known in the art. First valve core grooves 165a are in fluid communication with an internal axial passage 172 via radial passages 169. The axial passage 172 extends from the valve section 168 of the valve core 160 to the second end portion 166. The internal axial passage 172 communicates via passages (not shown) with the return line 28 (FIG. 1). Second valve core grooves 165b (FIG. 3) are in fluid communication with passages 174 in the valve sleeve 162, as will be explained below. The grooves 165b are not connected in direct fluid communication with the internal axial passage 172 or with radial passages corresponding to the passages 169.

The valve sleeve 162 (FIG. 2) has oppositely disposed first and second axial ends 180 and 182, respectively. The valve sleeve 162 includes a sleeve section 184 adjacent the first end 180 and a ball screw section 186 adjacent the second end 182. An axially extending passage 188 extends from the first end 180 of the valve sleeve 162 through the sleeve section 184 and the ball screw section 186 to the second end 182.

The first end 180 of the valve sleeve 162 includes first and second lugs (not shown) that are disposed in corresponding cut-outs (not shown) in the valve core 160. The cut-outs (not shown) are slightly wider than the lugs (not shown). As a result, upon rotation of the valve core 160 through an angle of between 2° and 8° relative to the valve sleeve 162, the lugs engage surfaces in the valve core to cause the valve sleeve to be rotated along with the valve core. As will be explained below, such rotation of the valve sleeve 162 causes the piston 142 to move axially in the chamber 136 and, hence, allows for manual steering of the vehicle even if a loss of hydraulic fluid pressure has occurred.

The sleeve section 184 of the valve sleeve 162 includes the passages 174 (FIG. 3), which extend from an outer circumferential surface 177 of the sleeve section to an inner circumferential surface 179 of the valve sleeve. The passages 174 communicate with a chamber 190 in the housing 132. The chamber 190 is in fluid communication with the hydraulic pump 20.

Axially extending grooves 170 and 171 (FIG. 3) are formed in the inner circumferential surface 179 of the valve sleeve 162, as is known in the art. The grooves 170 in the valve sleeve 162 communicate via passages 173 with the first chamber portion 138 (FIG. 2) in the housing 132. The grooves 171 (FIG. 3) communicate via passages 175 (FIG. 3) with the second chamber portion 140 (FIG. 2) in the housing 132. As is known in the art, when the valve core 160 is rotated relative to the valve sleeve 162, hydraulic fluid is ported through the grooves 171 and 172 and associated passages 173 and 175 to one of the chamber portions 138 and 140, and away from the other chamber portion, thereby causing the piston 142 to move accordingly.

When the vehicle wheels 15 are in a straight ahead condition, the valve core 160 and valve sleeve 162 are in the closed position illustrated in FIG. 3. At this time, the lands 167 on the valve core 160 are aligned with the grooves 170 and 171′ in the valve sleeve 162 to block fluid communication between the passages 174 and the passages 173 and 175. This is the result of the valve assembly 150 being a closed center valve assembly.

The general construction of the valve assembly 150 and fluid motor 131 is the same as is disclosed in U.S. Pat. No. 5,582,207. The valve assembly disclosed in that patent, however, is not a closed center valve.

The manual steering mechanism of the integral hydraulic steering gear 130 includes the inner bore 143 and helical groove 144 of the piston 142, and the ball screw section 186 (FIG. 2) of the valve sleeve 162. A helical groove 194 is formed on an outer periphery of the ball screw section 186. Multiple balls 196 are located in the helical groove 194. The balls 196 are also located in the helical groove 144 in the bore 143 formed in the piston 142. As is well known in the art, rotation of the ball screw portion 186 of the valve sleeve 162 causes axial movement of the piston 142.

A torsion bar 198 (FIG. 2) connects the valve core 160 and the valve sleeve 162. One end of the torsion bar 198 is connected by a pin 200 to the valve section 168 of the valve core 160. The other end of the torsion bar 198 extends through the passage 188 in the valve sleeve 162 and is connected by a pin 202 to the second end 182 of the valve sleeve.

From the above description, it should be apparent that rotation of the hand wheel 12 causes rotation of the valve core 160 of the steering gear 130 relative to the valve sleeve 162. Rotation of the valve core 162 causes axial movement of the piston 142 in one direction or the other. Axial movement of the piston 142 results in rotation of the sector gear and the pitman arm, thereby causing the road-engaging steerable wheels 15 to turn laterally of the vehicle.

In operation, when the hand wheel 12 is centered and the steerable wheels 15 are in a straight ahead orientation, the valve assembly 150 is in the closed position. In the closed position, the valve core 160 and valve sleeve 162 are positioned relative to one another so as to block the flow of hydraulic fluid to the chamber 136 of the fluid motor 131 from the accumulator 26.

When the driver starts to rotate the hand wheel 12 to turn the steerable wheels 15, the shaft 16 rotates the input shaft 152, which rotates the valve core 160 relative to the valve sleeve 162 to actuate the valve assembly 150 to the open position. In the open position, the grooves 165a, 165b, 170, and 171 in the valve core 160 and valve sleeve 162 are at least partially aligned to allow hydraulic fluid to flow from the accumulator 26 through the grooves and associated passages 169, 173, 174 to one of the chamber portions 138, 140 from the other chamber portion. This causes the piston 142 to move axially to assist the steering of the wheels. Axial movement of the piston 142 results in rotation of the sector gear 146 and the pitman arm, thereby causing the road-engaging steerable wheels 15 to turn.

During operation of the vehicle, the pressure sensor 54 continuously senses the pressure in the supply line 29 and outputs signals indicative of the pressure to the second electronic control unit 52. Also, the vehicle speed sensor 128 continuously senses the vehicle speed and outputs signals indicative of the vehicle speed to the first and second electronic control units 50, 52. The second electronic control unit 52 compares the signals from the sensors 54 and 128 and outputs a control signal to the electric motor 22 to cause the pump 20 to charge the accumulator 26 with hydraulic fluid at the desired pressure. The accumulator 26, in turn, supplies hydraulic fluid at the desired pressure to the integral steering gear 130. Simultaneously, the first electronic control unit 50 controls the electric motor 18 to provide the proper steering “feel” to the hand wheel 12 in response to the signals from the vehicle speed sensor 128 and torque/position sensor 30.

The advantages of supplying hydraulic fluid to the steering gear 130 with the closed center valve assembly 150 at a pressure that is controlled as described above are threefold. First, by controlling the pressure in the accumulator 26, the hydraulic fluid will be supplied to the steering gear 130 at a pressure that more accurately corresponds to the required steering force at the wheels 15. Thus, at higher vehicle speeds the steering force required is reduced, and a lower accumulator pressure can be maintained. Second, when the vehicle is moving and the closed-center valve assembly 150 opens, the initial flow of hydraulic fluid will be at a lower pressure as compared to typical closed center valve steering systems. This reduces the disturbance or “bump” experienced at the hand wheel 12. With a smaller disturbance, the motor 18, in response to the signal from the column torque sensor 122, will be better able to mask the disturbance felt by the operator. The third advantage is that the lower pressure of the hydraulic fluid flow reduces leakage through the closed-center valve assembly 150, thereby saving energy.

In view of the description above, those skilled in the art will become aware of modifications and changes which may be made in the present invention, and such modifications and changes are intended to be covered by the appended claims. For example, the second electronic control unit 52 could be configured to determine the pressure of the supply line 29 directly without the use of a pressure sensor. This could be achieved by monitoring the speed of the motor 22, for example.

Having described the invention, what is claimed is:

1. An apparatus for helping to turn steerable wheels of a vehicle, the apparatus comprising:
a hydraulic power-assisted steering gear;
a fluid source for supplying the steering gear with hydraulic fluid;
a controller for controlling the fluid source;
said steering gear including a closed center valve operatively connected with a vehicle steering wheel and in fluid communication with said fluid source;
said controller being responsive to the pressure of the hydraulic fluid for controlling the fluid source to supply the steering gear with hydraulic fluid at a first predetermined pressure when the vehicle is in a first condition; and
said controller being responsive to the pressure of the hydraulic fluid for controlling the fluid source to supply the steering gear with hydraulic fluid at a second predetermined pressure when the vehicle is in a second condition.

2. The steering apparatus of claim 1 wherein said fluid source includes (a) a pump connected to said steering gear through a fluid line and (b) a pressure sensor for sensing the pressure in said fluid line and for generating a pressure signal indicative of the sensed pressure in said fluid line, said controller receiving the pressure signal.

3. The steering apparatus of claim 2 wherein said steering gear includes a hydraulic motor for turning the steerable road-engaging wheels,
said closed center valve having an open position allowing the flow of hydraulic fluid from the fluid source to the hydraulic motor to effect turning of the steerable wheels; and
said closed center valve having a closed position blocking the flow of hydraulic fluid to the hydraulic motor from the fluid source when no turning of the steerable wheels is underway,
said closed center valve being moved from said closed position to said open position by movement of said steering wheel.

4. The steering apparatus of claim 3 wherein said fluid source includes an accumulator for storing high pressure hydraulic fluid, said accumulator being in fluid communication with said pump, said pump supplying hydraulic fluid to said accumulator when activated, hydraulic fluid from said accumulator flowing to said hydraulic motor when said closed center valve is in said open position.

5. The steering apparatus of claim 1 wherein said first condition is when the vehicle is traveling at a first speed, said second condition being when the vehicle is traveling at a second speed.

6. The steering apparatus of claim 2, including a motor for operating the pump, said controller being operatively connected to said motor.

7. The steering apparatus of claim 1 including an electric motor operatively connected to said steering wheel, for when activated, resisting rotation of said steering wheel to provide steering feel to a driver of the vehicle during steering of the steerable wheel.
